(19) United States
(12) Patent Application Publication
(10) Pub. No.: US 2014/0023419 A1
(43) Pub. Date: Jan. 23, 2014

(54) PRINT CARTRIDGE WITH SENSOR PINS

(71) Applicant: Clover Technologies Group, LLC, Ottawa, IL (US)

(72) Inventor: John Morgan, Newbury Park, CA (US)

(21) Appl. No.: 13/926,330

(22) Filed: Jun. 25, 2013

Related U.S. Application Data
(60) Provisional application No. 61/672,587, filed on Jul. 17, 2012.

(51) Int. Cl. B41J 15/04

(52) U.S. Cl. CPC B41J 15/044
USPC 400/613

(57) ABSTRACT

A print cartridge configured for insertion into a recess of a printer having a plurality of sensor plungers arranged in the recess. The print cartridge includes a length of print tape having at least one characteristic, and a body containing the length of print tape. The body includes a print head receiving recess and an indicator portion spaced from the recess. The indicator portion includes at least one pin. An arrangement of the at least one pin corresponds to the at least one characteristic of the length of print tape, and each at least one pin is configured to engage a corresponding one of the sensor plungers when the print cartridge is inserted into the recess. The arrangement of pins that engage the sensor plungers allows the printer to identify the at least one characteristic of the print tape.

### CROSS-REFERENCE TO RELATED APPLICATION

This application claims the benefit of and priority to U.S. Provisional Patent Application No. 61/672,587, filed Jul. 17, 2012, the entire contents of which are hereby incorporated by reference herein.

### TECHNICAL FIELD

The present invention relates generally to a cartridge for a printer, and more particularly to a print cartridge for a label printer having sensor pins for interacting with the printer.

### BACKGROUND

Label printers are known for printing text and graphics onto elongated strips of print media. The print media can be different widths, colors, and the like, and is generally supplied on print cartridges that include one or more rolls of the print media. Some label printers use different print settings depending upon the type of print media that is being used. It is therefore desirable to configure the label printer and the print cartridge in a manner that allows the label printer to identify the type of print media that is carried by the print cartridge.

### SUMMARY

In some aspects, a print cartridge is configured for insertion into a recess of a printer, the printer including a plurality of sensor plungers arranged in the recess. The print cartridge includes a length of print tape having at least one characteristic, and a body containing the length of print tape. The body includes a print head receiving recess, a gap associated with the recess, and an indicator portion spaced from the recess. The indicator portion includes at least one pin. A portion of the length of print tape extends across the gap, an arrangement of the at least one pin corresponds to the at least one characteristic of the length of print tape, and each at least one pin is configured to engage a corresponding one of the sensor plungers when the print cartridge is inserted into the recess.

In other aspects, a print cartridge body is configured for insertion into a recess of a printer, the printer including a plurality of sensor plungers arranged in the recess. The print cartridge body includes a first corner defining a print head receiving recess and a gap associated with the recess, and a second corner defining an indicator portion. The indicator portion includes at least one pin. Each at least one pin is configured to engage a corresponding one of the sensor plungers when the print cartridge body is inserted into the recess.

In still other aspects, a print cartridge is configured for insertion into a recess of a printer, the printer including a plurality of sensor plungers arranged in the recess. The print cartridge includes a length of print tape having at least one characteristic, and a body containing the length of print tape. The body includes a print head receiving recess located at a first corner of the body, and a gap associated with the recess. The body further includes an indicator portion located at a second corner of the body diametrically opposite the first corner, and a bottom wall that faces the recess when the print cartridge is inserted into the recess. The indicator portion includes a recess surface that is recessed from the bottom wall, and at least one pin extending substantially perpendicularly from the recess surface toward the bottom wall. Each at least one pin includes a height that is equal to or greater than an activation distance associated with the sensor plungers. A portion of the length of print tape extends across the gap, an arrangement of the at least one pin corresponds to the at least one characteristic of the length of print tape, and each at least one pin is configured to engage a corresponding one of the sensor plungers when the print cartridge is inserted into the recess.

### BRIEF DESCRIPTION OF THE DRAWINGS

To understand the present invention, it will now be described by way of example only, not by way of limitation, with reference to the accompanying drawings.

FIG. 1 is a perspective view of a cartridge receiving recess in a label printer including a plurality of sensor plungers.

FIG. 2 is bottom view of a print cartridge adapted to fit within the cartridge receiving recess of the label printer of FIG. 1.

FIG. 3 is a section view taken along line 3-3 of FIG. 2.

### DETAILED DESCRIPTION

While the subject matter of this disclosure can be embodied in many different forms, there is shown in the drawings and will herein be described in detail at least one specific embodiment with the understanding that the present disclosure is to be considered as an exemplification of certain principles and is not intended to limit the broad aspects of the disclosed subject matter to the embodiment(s) illustrated.

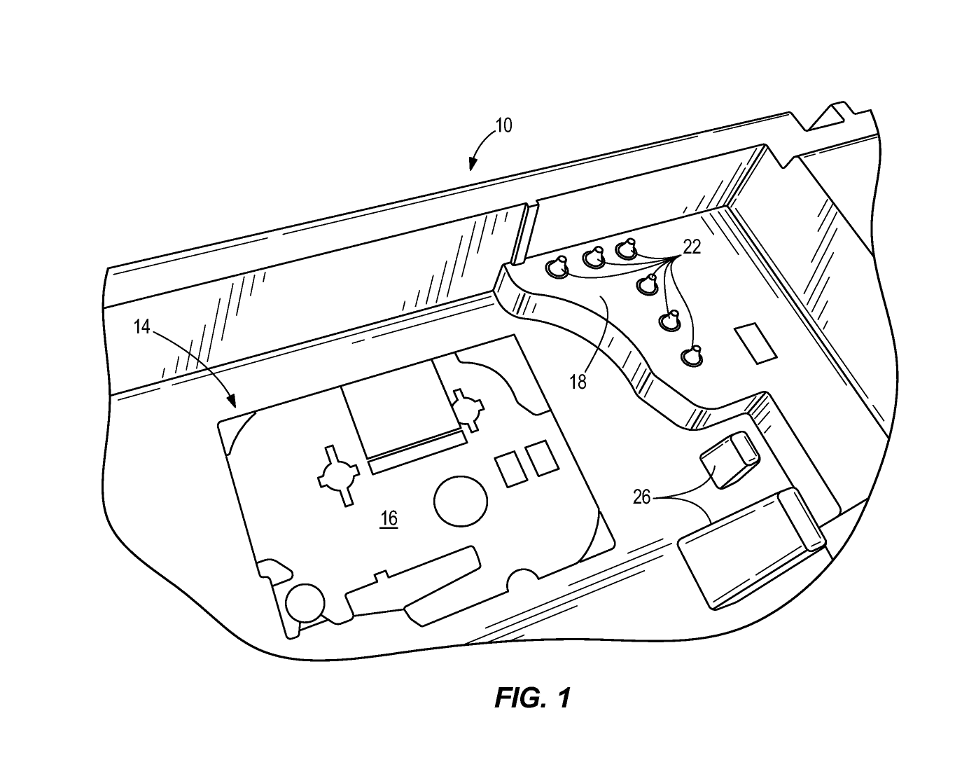

FIG. 1 illustrates an exemplary label printer 10 defining a cartridge-receiving recess 14 for receiving a print cartridge (not shown). The recess 14 is generally rectangular and includes a floor 16 and an elevated portion 18 in one corner that is elevated with respect to the floor 16. A plurality of sensor plungers 22 extend through the elevated portion 18 and are configured to assist the printer 10 in determining what type of print cartridge is installed in the recess 14, as discussed further below. The sensor plungers 22 are depressible into the elevated portion 18 and arranged generally in an L-shape, but other configurations are also possible. The recess 14 also includes at least one alignment projection 26 that extends upwardly from the floor 16 of the recess 14. As shown, the illustrated printer 10 includes two alignment projections 26.

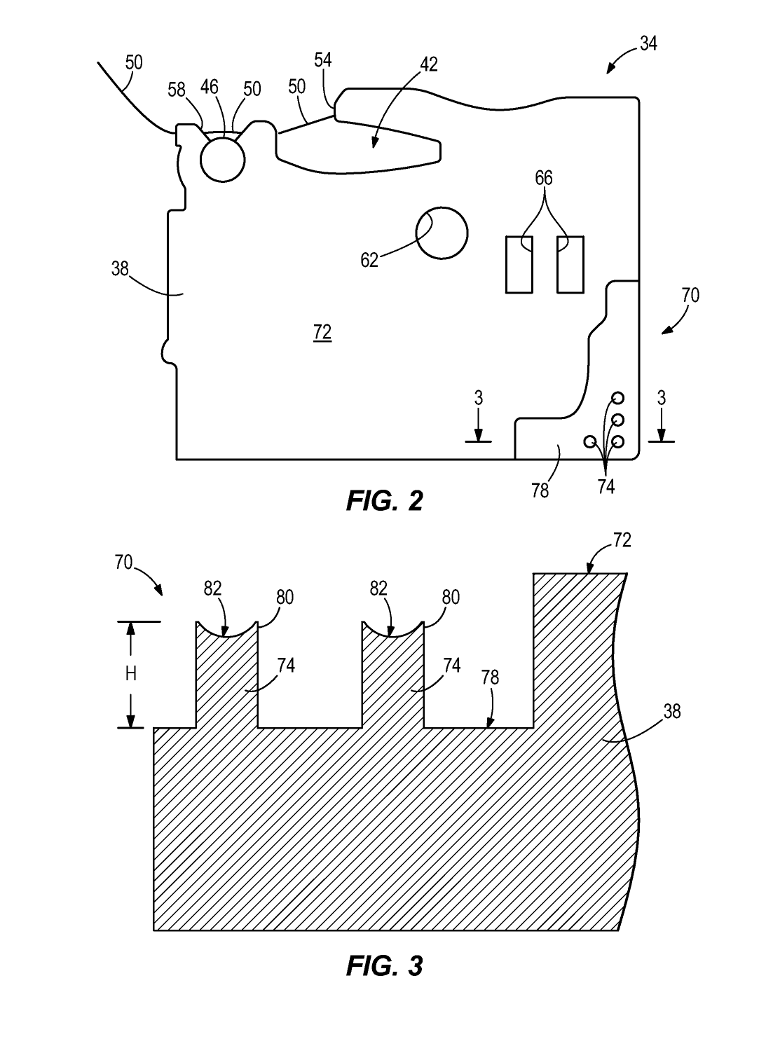

Referring also to FIG. 2, a print cartridge 34 configured for insertion into the recess 14 is shown and includes a generally rectangular body 38. One corner of the body 38 defines a print head receiving recess 42 that receives a print head (not shown) of the printer 10, and a tape feed roller 46 that receives a drive pin (not shown) of the printer 10. Print tape 50 extends across a first gap 54 associated with the recess 42, and through a second gap 58 associated with the feed roller 46. The print tape 50 extends out of the body 38 through a slot (not shown) adjacent the feed roller 46. The body 38 also defines a take up opening 62 into which a take up pin (not shown) of the printer 10 extends for rotating a take up spool located within the cartridge 34. A pair of rectangular openings 66 generally adjacent the take up opening 62 are configured to receive one or more of the alignment projections 26 provided in the recess 14 of the printer 10.

Referring also to FIG. 3, the body 38 of the print cartridge 34 further includes an indicator portion 70. In the illustrated embodiment, the indicator portion 70 is located at a corner of the body 38 diametrically opposite the feed roller 46. The indicator portion 70 is recessed with respect to a bottom wall 72 of the cartridge 34 and includes a recess surface 78. The recess surface 78 is recessed from the bottom wall 72 of the cartridge by an amount equal to or greater than the sum of a height of the elevated portion 18 above the floor 16 of the recess 14 and an extended height of the sensor plungers 22 (see FIG. 1). The indicator portion 70 also includes at least one pin 74 (four pins 74 being shown in FIG. 2) positioned for engagement with a corresponding one of the sensor plungers 22 when the print cartridge 34 is installed in the recess 14. In the illustrated embodiment, the pins 74 each include an end 80 having a concaved surface 82. The individual surfaces 82 are each configured to receive and engage an individual one of the sensor plungers 22. For example, each concaved surface 82 functions to prevent its respective sensor plunger 22 from deflecting toward the sides of the respective pin 74 when the pin 74 engages the sensor plunger 22. Other end configurations are also possible, such as flat ends, frusto-conically indented ends, and the like. In some embodiments, the sensor plungers 22 and the pins 74 can be provided with mutually interlocking features, such as a convex sensor plunger 22 and the illustrated ends 80 having concaved surfaces 82, without limitation.

The sensor plungers 22 are biased toward the extended position shown in FIG. 1. When the print cartridge 34 is first inserted into the recess 14, the pins 74 align with certain ones of the sensor plungers 22 and, as the print cartridge 34 is fully seated in the recess 14, each pin 74 depresses its respective the sensor plunger 22 inwardly. The printer 10 includes sensor circuitry associated with the sensor plungers 22 such that the printer 10 can detect which sensor plungers 22 are depressed and which sensor plungers 22 remain extended. The pins 74 have a height H equal to or greater than an activation distance associated with the sensor plungers 22. In the exemplary configuration, the activation distance is a distance that the sensor plungers 22 must be pushed into the elevated portion 18 to change the state of the sensor circuitry (e.g. from open to closed) associated with the sensor plungers 22. The height H is measured from the recess surface 78 to the portion of the end 80 of the pin 74 that contacts the sensor plunger 22.

Based on which sensor plungers 22 are depressed and which sensor plungers 22 remain extended, the printer 10 is able to determine what type of print cartridge 34 is positioned in the recess 14, and based on that information can adjust various print settings as needed to accommodate the specific type of print cartridge 34. For example, the illustrated print cartridge 34 having three pins 74 may be a print cartridge having black ink and ½ inch thick white tape. A different print cartridge 34 having, for example, red ink and ¾ inch thick white tape, may have a different number or arrangement of pins 74, such as a single pin located in the outer-most corner of the indicator portion 70. In this regard, there are numerous combinations of tape thickness, tape color, ink color, and/or other ribbon characteristics, and each combination can be provided with a specific number and arrangement of pins 74 such that the printer 10 can identify the print cartridge 34 based on which sensor plungers 22 are depressed when the print cartridge 34 is positioned in the recess 14. The specific arrangement of pins 74 needed to identify a particular print cartridge 34 to the printer 10 is generally determined by programming within the printer 10 that correlates the depression of specific sensor plungers 22 with a specific type of print cartridge 34.

Several alternative examples have been described and illustrated herein. A person of ordinary skill in the art would appreciate the features of the individual embodiments, and the possible combinations and variations of the components. A person of ordinary skill in the art would further appreciate that any of the examples could be provided in any combination with the other examples disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the word “including” as used herein is utilized in an open-ended manner.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A print cartridge configured for insertion into a recess of a printer, the printer including a plurality of sensor plungers arranged in the recess, the print cartridge comprising:
a length of print tape, the print tape having at least one characteristic;
a body containing the length of print tape, the body including a print head receiving recess, a gap associated with the recess, and an indicator portion spaced from the recess, the indicator portion including at least one pin, wherein a portion of the length of print tape extends across the gap, wherein an arrangement of the at least one pin corresponds to the at least one characteristic of the length of print tape, and wherein each at least one pin is configured to engage a corresponding one of the sensor plungers when the print cartridge is inserted into the recess.

2. The print cartridge of claim 1, wherein the recess is located at a first corner of the body, and the indicator portion is located at a second corner of the body diametrically opposite the first corner.

3. The print cartridge of claim 1, wherein the body includes a bottom wall that faces the recess when the print cartridge is inserted into the recess, and wherein the indicator portion includes a recess surface that is recessed from the bottom wall.

4. The print cartridge of claim 3, wherein each at least one pin extends from the recess surface toward the bottom wall.

5. The print cartridge of claim 4, wherein each at least one pin extends substantially perpendicularly from the recess surface.

6. The print cartridge of claim 1, wherein each at least one pin includes an end having a concaved surface, and wherein the concaved surface engages the corresponding one of the sensor plungers when the print cartridge is inserted into the recess.

7. The print cartridge of claim 1, wherein each at least one pin extends from a surface of the indicator portion and includes a height that is equal to or greater than an activation distance associated with the sensor plungers.

8. The print cartridge of claim 1, wherein the at least one characteristic of the print tape includes at least one of a width of the print tape and a color of the print tape.

9. A print cartridge body configured for insertion into a recess of a printer, the printer including a plurality of sensor plungers arranged in the recess, the print cartridge body comprising:
a first corner defining a print head receiving recess and a gap associated with the recess;
a second corner defining an indicator portion, the indicator portion including at least one pin, wherein each at least one pin is configured to engage a corresponding one of the sensor plungers when the print cartridge body is inserted into the recess.

10. The print cartridge body of claim 9, wherein the second corner is diametrically opposite the first corner.

11. The print cartridge body of claim 9, further comprising a bottom wall that faces the recess when the print cartridge body is inserted into the recess, and wherein the indicator portion includes a recess surface that is recessed from the bottom wall.

12. The print cartridge body of claim 11, wherein each at least one pin extends from the recess surface toward the bottom wall.

13. The print cartridge body of claim 12, wherein each at least one pin extends substantially perpendicularly from the recess surface.

14. The print cartridge body of claim 9, wherein each at least one pin includes an end having a concaved surface, and wherein the concaved surface engages the corresponding one of the sensor plungers when the print cartridge body is inserted into the recess.

15. The print cartridge body of claim 9, wherein each at least one pin extends from a surface of the indicator portion and includes a height that is equal to or greater than an activation distance associated with the sensor plungers.

16. A print cartridge configured for insertion into a recess of a printer, the printer including a plurality of sensor plungers arranged in the recess, the print cartridge comprising:
a length of print tape, the print tape having at least one characteristic;
a body containing the length of print tape, the body including a print head receiving recess located at a first corner of the body, and a gap associated with the recess, the body further including an indicator portion located at a second corner of the body diametrically opposite the first corner, and a bottom wall that faces the recess when the print cartridge is inserted into the recess, the indicator portion including a recess surface that is recessed from the bottom wall, and at least one pin extending substantially perpendicularly from the recess surface toward the bottom wall, each at least one pin including a height that is equal to or greater than an activation distance associated with the sensor plungers, wherein a portion of the length of print tape extends across the gap, wherein an arrangement of the at least one pin corresponds to the at least one characteristic of the length of print tape, and wherein each at least one pin is configured to engage a corresponding one of the sensor plungers when the print cartridge is inserted into the recess.

17. The print cartridge of claim 16, wherein each at least one pin includes an end having a concaved surface, and wherein the concaved surface engages the corresponding one of the sensor plungers when the print cartridge is inserted into the recess.

18. The print cartridge of claim 16, wherein the at least one characteristic of the print tape includes at least one of a width of the print tape and a color of the print tape.
